(19) United States
(12) Patent Application Publication
(10) Pub. No.: US 2019/0372445 A1
(43) Pub. Date: Dec. 5, 2019

(54) BRUSH MOTOR

(71) Applicant: Hanon Systems, Daejeon (KR)

(72) Inventors: In Keun KANG, Daejeon (KR); Gyu Ik HAN, Daejeon (KR)

(21) Appl. No.: 16/316,915

(22) PCT Filed: Jan. 23, 2018
(86) PCT No.: PCT/KR2018/000987

§ 371 Date: Jan. 10, 2019

(30) Foreign Application Priority Data
Jan. 26, 2017 (KR) 10-2017-0012631
Apr. 6, 2017 (KR) 10-2017-0044648

(51) Int. Cl. H02K 23/22; H02K 1/17; H02K 23/04; F04D 25/06

(52) U.S. Cl. CPC H02K 23/22; H02K 1/17; H02K 2213/03; F04D 25/06; H02K 23/04

(57) ABSTRACT

A brush motor having a 4-pole 24-slot 2-brush structure includes a motor housing, a plurality of stators provided at intervals on an inner circumferential surface of the motor housing, a rotor rotatably installed inside the stators, a plurality of commutators installed on a rotation center shaft of the rotor, and a plurality of brushes configured to supply electric power to the commutators, the rotor including a plurality of slots formed at intervals on an outer circumferential surface thereof and a plurality of coils wound in the slots. The number of the stators is four, the number of the brushes is two, the number of the slots is twenty four, and the number of the coils is twenty four.

### TECHNICAL FIELD

The present invention relates to a brush motor and, more particularly, to a brush motor which has a structure of 4 poles, 24 slots and 2 brushes and which is capable of reducing the size and weight of the motor by optimizing the pole arc/angle ratio, which is a ratio of a magnet width to a pole gap, and capable of improving the rotation performance of the motor by minimizing the generation of a cogging torque and a ripple current due to a magnetic field change between a rotor and a stator.

### BACKGROUND ART

A motor vehicle is equipped with an air conditioner to control the temperature in a passenger compartment. Such an air conditioner includes various actuators, one example of which is a blower motor.

The blower motor rotates a blower fan while being operated in response to an applied control signal. Therefore, the blower fan can suck an air existing inside or outside the passenger compartment.

In general, a blower motor for an air conditioner is composed of 2 poles, 12 slots and 2 brushes as shown in FIG. 1.

In the blower motor having such a structure, when the electric power is applied to commutators 3 through brushes 1, a magnetic field is generated in coils 6 of slots 5 by the applied electric power. The generated magnetic field applies an attraction force and a repulsion force to the stator 7 to generate a torque. A rotor 8 is rotated by the torque thus generated.

However, such a conventional blower motor is disadvantageous in that it is relatively heavy in weight and large in volume as compared with an output. This is a great obstacle in reducing the size and weight of an air conditioner.

Particularly, in recent years, the air conditioner has to be downsized, slimmed and weight-reduced along with the trend toward miniaturization, slimness and lightweight of a motor vehicle. However, the conventional 2-pole 12-slot type blower motor, which is heavy and bulky, has a difficulty in downsizing, slimming and weight-reducing the air conditioner.

Since the conventional blower motor has a 2-pole 12-slot type structure, a large cogging torque is generated during rotation due to the change in attraction force between the coils 6 of the rotor 8 and the stator 7.

Due to this large cogging torque, vibrations are generated in the rotor 8 and the rotational speed of the rotor 8 is changed.

In addition, according to the conventional blower motor, in the process of applying electricity to the coils 6 of the rotor 8, a ripple current is generated due to the periodic change in attraction force between the coils 6 and the stator 7 and the resultant change in magnetic field. This ripple current becomes very large due to the 2-pole 12-slot type structure.

Particularly, when the voltage applied to the motor is increased in order to increase the rotation speed of the blower, as shown in FIG. 2, the amplitude of the ripple current becomes larger, thereby generating noise and damaging a battery and various electric devices.

### SUMMARY

In view of the aforementioned problems inherent in the related art, it is an object of the present invention to provide a brush motor capable of significantly reducing the weight and size thereof through structural improvement.

Another object of the present invention is to provide a brush motor capable of reducing the size and weight thereof and consequently making it possible to reduce the size and weight of an air conditioner.

A further object of the present invention is to provide a brush motor capable of reducing a cogging torque generated between coils of a rotor and a stator during rotation by improving an internal structure.

A still further object of the present invention is to provide a brush motor capable of reducing a cogging torque, reducing the vibration of a rotor and the fluctuation of a rotation speed of the rotor caused by the cogging torque, and consequently improving the rotation performance.

A yet still further object of the present invention is to provide a brush motor capable of minimizing the generation of a ripple current in a process of applying electricity to coils of a rotor.

An even yet still further object of the present invention is to provide a brush motor capable of minimizing the generation of a ripple current in a process of applying electricity to coils of a rotor, thereby preventing generation of noise due to a ripple current and preventing damage to a battery and various electric devices.

According to one aspect of the present invention, there is provided a brush motor having a 4-pole 24-slot 2-brush structure, including: a motor housing; a plurality of stators provided at intervals on an inner circumferential surface of the motor housing; a rotor rotatably installed inside the stators; a plurality of commutators installed on a rotation center shaft of the rotor; and a plurality of brushes configured to supply electric power to the commutators, the rotor including a plurality of slots formed at intervals on an outer circumferential surface thereof and a plurality of coils wound in the slots, wherein the number of the stators provided at intervals on the inner circumferential surface of the motor housing is four, the number of the brushes configured to supply electric power to the commutators is two, the number of the slots of the rotor for generating a rotation torque while exerting an attraction force and a repulsion force with respect to the four stators when energized or de-energized by the electric power is twenty four, and the number of the coils wound in the slots is twenty four.

Preferably, each of the stators may have a varying thickness along a width direction corresponding to a circumferential direction of the rotor.

Each of the stators may have a largest thickness in a width direction middle portion and a gradually decreasing thickness in both edge portions.

A thickness ratio of the width direction middle portion to both edge portions may be 10:4.

A pole arc/angle ratio in each of the stators may fall within a range of 0.88 to 0.92.

The pole arc/angle ratio in each of the stators may be set to satisfy the following equation (1):

0.88 L1/R1≤0.92 (1)

where L1 denotes a length of one of permanent magnets provided in each of the stators, and R1 denotes a length obtained by dividing the circumferential length of a circle formed by a surface on which permanent magnets are located, by the number of permanent magnets.

The brush motor according to the present invention has a structure of 4 poles, 24 slots and 2 brushes. Thus, the brush motor can have an output equivalent to that of a conventional brush motor of a 2-pole 12-slot 2-brush structure while reducing the size of coils of a rotor and stators. Thus makes it possible to reduce the size and weight of the brush motor.

Further, since the brush motor has a structure capable of reducing the size and weight thereof, it is possible to achieve the downsizing, slimming and weight-reducing of an air conditioner.

In addition, since the brush motor has a structure of 4 poles, 24 slots and 2 brushes, it is possible to reduce the size of coils of a rotor and stators without loss of a rotation torque, consequently reducing a cogging torque generated between the coils of the rotor and the stators.

Since the cogging torque between the rotor and the stators can be reduced, it is possible to reduce the vibration of a rotor and the fluctuation of a rotation speed of the rotor caused by the cogging torque, consequently improving the rotation performance of the motor.

Furthermore, since the brush motor has a structure of 4 poles, 24 slots and 2 brushes, it is possible to reduce the size of coils of a rotor and stators without loss of a rotation torque, eventually reducing a ripple current generated due to a change in magnetic field between coils and stators.

Moreover, by reducing the ripple current generated due to the change in magnetic field between the coils and the stators, it is possible to prevent generation of noise due to the ripple current and to prevent damage to a battery and various electric devices.

In addition, since the brush motor has a structure of 4 poles, 24 slots and 2 brushes so as to optimize a pole arc/angle ratio, which is a ratio of a magnet width to a pole gap, it is possible to reduce the size and weight of the brush motor and to minimize the generation of a cogging torque and a ripple current due to the change in magnetic field between the rotor and the stators.

### BRIEF DESCRIPTION OF THE DRAWINGS

FIG. 1 is a sectional view showing a configuration of a conventional brush motor.

FIG. 2 is a graph showing an operation example of a conventional brush motor, in which a change in torque ripple of a motor according to application of electricity is shown.

FIG. 3 is a side sectional view showing a configuration of a brush motor according to the present invention.

FIG. 4 is a cross-sectional view taken along line IV-IV in FIG. 3, which shows in detail the main features of the brush motor according to the present invention.

FIG. 5 is a graph showing an operation example of the brush motor according to the present invention, in which a change in torque ripple of a motor according to application of electricity is shown.

FIG. 6 is a graph showing a cogging torque according to a pole arc/angle ratio in a DC motor having a 4-pole 24-slot 2-brush structure.

FIG. 7 is a graph showing an unbalanced electromagnetic force according to a pole arc/angle ratio.

FIG. 8 is a table numerically summarizing a cogging torque and an unbalanced electromagnetic force when a pole arc/angle ratio is within a range of 0.88 to 0.92.

FIG. 9 is a perspective view showing in detail a stator constituting the brush motor of the present invention.

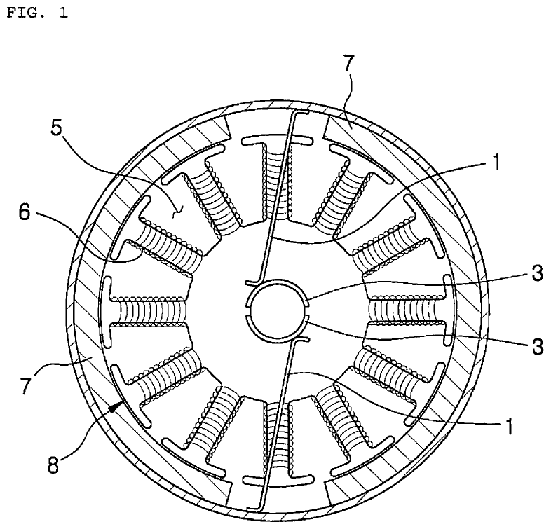

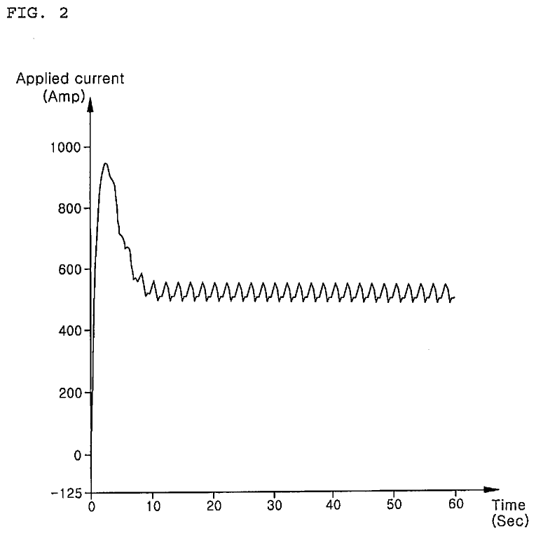

### DETAILED DESCRIPTION

A preferred embodiment of a brush motor according to the present invention will now be described in detail with reference to the accompanying drawings.

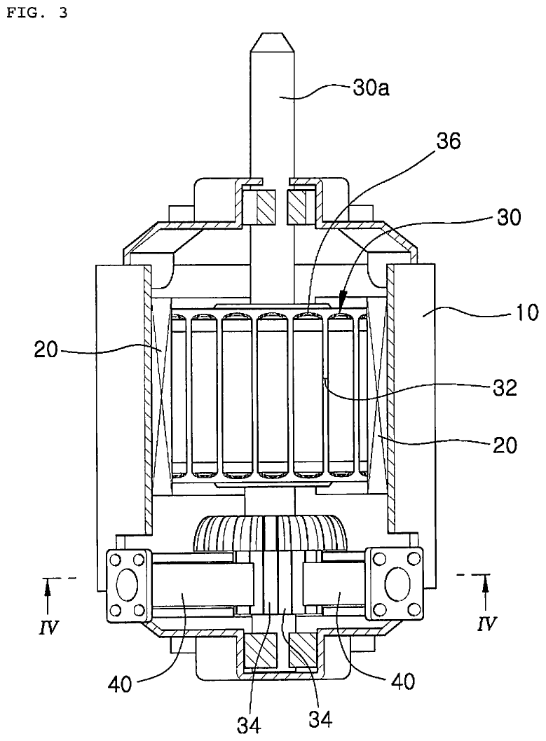

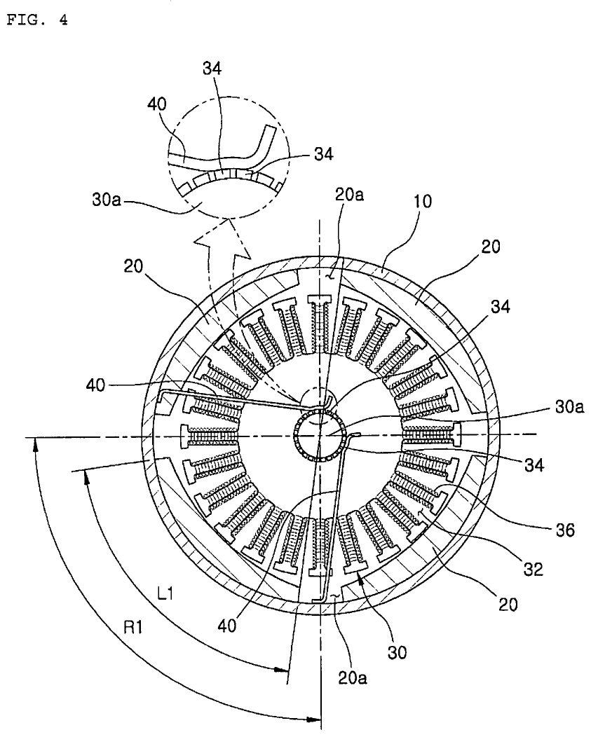

Prior to describing features of a brush motor according to the present invention, the brush motor will be briefly described with reference to FIGS. 3 and 4.

The brush motor includes a cylindrical motor housing 10. Stators 20 are installed on the inner circumferential surface of the motor housing 10 at predetermined intervals 20a. A rotor 30 is rotatably installed inside the stators 20.

The rotor 30 has a plurality of slots 32 formed at intervals on the outer circumferential surface thereof and commutators 34 installed at a predetermined interval on the outer surface of a rotation center shaft 30a. In particular, the slots 32 are formed at intervals along the circumferential direction of the rotor 30. Coils 36 are wound around the rotor 30.

The brush motor includes a pair of brushes 40 installed to extend from the motor housing 10 toward the commutators 34 of the rotor 30. The brushes 40 make frictional contact with the commutators 34 of the rotor 30 to intermittently supply electric power to the commutators 34.

In the brush motor, when the electric power is supplied to the commutators 34 through the brushes 40, the coils 36 of the rotor 30 are energized and de-energized by the applied electric power to generate an attraction force and a repulsion force with respect to the stators 20. The rotor 30 is rotated by a rotation torque generated by the attraction force and the repulsion force with respect to the stators 20.

Next, the features of the brush motor according to the present invention will be described in detail with reference to FIGS. 3 to 9.

Referring first to FIGS. 3 and 4, the brush motor of the present invention includes stators 20 disposed on the inner circumferential surface of the motor housing 10, in which the number of stators 20 is four.

The four stators 20 are provided on the inner circumferential surface of the motor housing 10 at regular intervals 20a and are installed so that S poles and N poles are alternately arranged with each other.

When the coils 36 wound on the rotor 30 are energized and de-energized, the four stators 20 generate a rotation torque while exerting an attraction force and a repulsion force with the coils 36. Thus, the rotor 30 can be rotated by the generated rotation torque.

The brush motor of the present invention includes 24 slots 32 formed in the rotor 30 and 24 commutators 34 provided in the rotation center shaft 30a of the rotor 30.

Since the rotor 30 having such a configuration has 24 commutators 34 and 24 slots 32 so that the number of the coils 36 wound around the slots 32 is 24.

Thus, the brush motor of the present invention can be formed to have a 4-pole 24-slot 2-brush structure includes 4 stators 20 and 24 slots 32.

The number of slots 32, the number of coils 36 and the number of stators 20 corresponding thereto are increased in the brush motor having a 4-pole 24-slot 2-brush structure.

Therefore, under the same size condition as that of a motor having a 2-pole 12-slot 2-brush structure, it is possible to increase the attraction force and the repulsion force generated between the coils 36 of the rotor 30 and the stators 20 and the resultant rotation torque.

Therefore, even if the size and weight of the brush motor of the present invention are set smaller than those of a motor having a 2-pole 12-slot 2-brush structure, the brush motor of the present invention may have an output equivalent to that of the motor having a 2-pole 12-slot 2-brush structure.

In particular, even if the size of the coils 36 of the rotor 30 and the size of the stators 20 are reduced, the brush motor of the present invention may have an output equivalent to that of the motor having a 2-pole 12-slot 2-brush structure.

As a result, it is possible to reduce the size and weight of the brush motor, whereby the air conditioner can be made smaller, slimmer and lighter.

In the brush motor having a 4-pole 24-slot 2-brush structure, the number of the slots 32, the coils 36 and the stators 20 is increased. Thus, even if the size of the coils 36 of the rotor 30 and the size of the stators 20 are reduced, the brush motor of the present invention may have an output equivalent to that of the motor having a 2-pole 12-slot 2-brush structure.

Therefore, the cogging torque generated between the coils 36 of the rotor 30 and the stators 20 can be remarkably reduced due to the reduced size of the coils 36 of the rotor 30 and the reduced size of the stators 20. In particular, as compared with a motor having a 2-pole 12-slot 2-brush structure, it is possible to remarkably reduce the cogging torque generated between the rotor 30 and the stators 20.

As a result, it is possible to remarkably reduce the vibration of the rotor 30 and the fluctuation in the rotation speed of the rotor 30 caused by the cogging torque, thereby improving the rotation performance of the motor.

Further, according to the brush motor having a 4-pole 24-slot 2-brush structure, by increasing the number of the slots 32, the coils 36 and the stators 20, it is possible to reduce the size of the coils 36 of the rotor 30 and the size of the stators 20 without loss of the attraction force and the repulsion force between the rotor 30 and the stators 20 and the rotation torque.

Therefore, due to the reduced size of the coils 36 of the rotor 30 and the reduced size of the stators 20, it is possible to remarkably reduce the ripple current generated due to the change in attraction force between the coils 36 and the stators 20 and the resultant change in magnetic field.

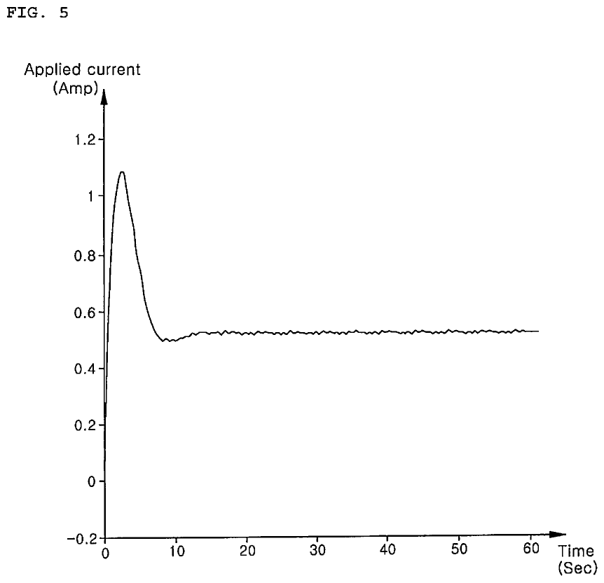

In particular, even if the voltage applied to the motor is increased in order to increase the rotation speed of a blower, the amplitude of the ripple current can be remarkably reduced as shown in FIG. 5.

As a result, noise caused by the ripple current can be prevented, and damage to a battery and various electric devices can be prevented.

Referring to FIG. 4, the brush motor of the present invention has a feature that the pole arc/angle ratio, which means a ratio of a magnet width to a pole gap, is 0.88 to 0.92.

At this time, the pole arc/angle ratio of the stators 20 can be defined by the following equation (1):

0.88≤L1/R1≤0.92 (1)

where L1 denotes a length of one of permanent magnets provided in each of the stators 20, and R1 denotes a length obtained by dividing the circumferential length of a circle formed by a surface on which permanent magnets are located, by the number n of permanent magnets.

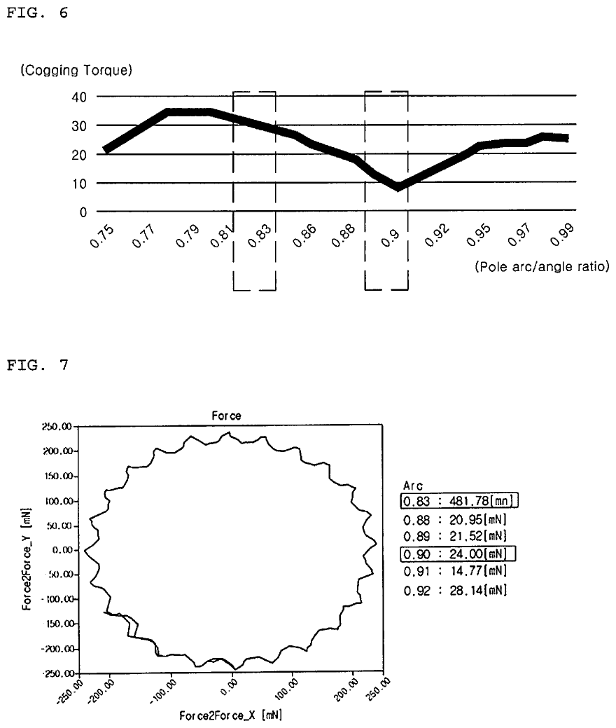

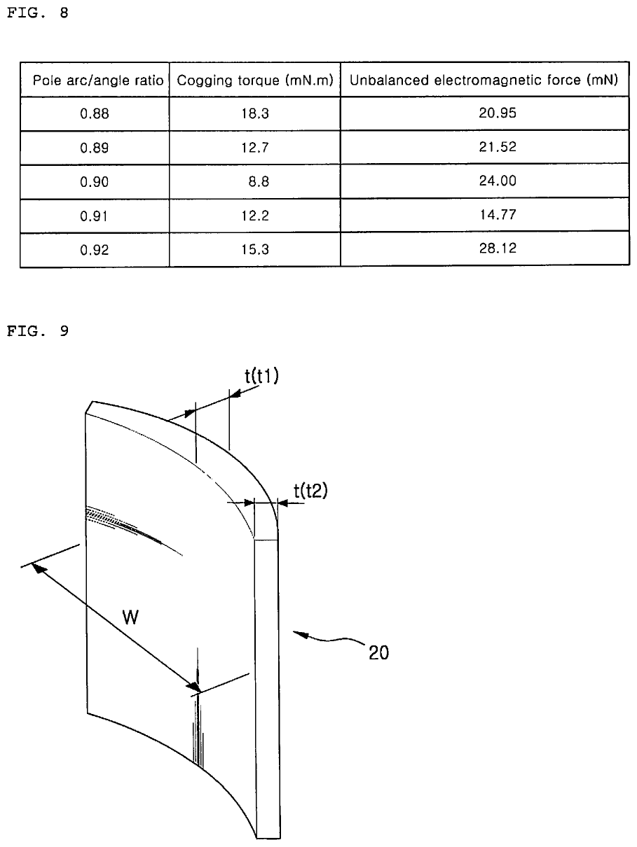

FIG. 6 is a graph showing a cogging torque according to a pole arc/angle ratio in a DC motor having a 4-pole 24-slot 2-brush structure, and FIG. 7 is a graph illustrating an unbalanced electromagnetic force according to a pole arc/angle ratio. FIG. 8 is a table numerically summarizing the cogging torque and the unbalanced electromagnetic force when the pole arc/angle ratio falls within a range of 0.88 to 0.92.

As shown in FIGS. 6 and 8, even though the structures of DC motors having a 4-pole 24-slot 2-brush structure are the same, the characteristics of the cogging torque and the unbalanced electromagnetic force vary depending on the pole arc/angle ratio. Therefore, it is desirable that the pole arc/angle ratio is designed to fall within a range of 0.88 to 0.92 in order to minimize the cogging torque and the electromagnetic force.

For example, in the case of a DC motor having a 4-pole 24-slot 2-brush structure, if the radius of a circle formed by permanent magnets is assumed to be 5 cm, then R1 is (2π×5)/4=7.85 cm. Thus, it is desirable that the length L1 of one of permanent magnets is designed to satisfy 6.908 cm≤L1≤7.222 cm.

Thus, in the 4-pole 24-slot 2-brush motor of the present invention having an optimized pole arc/angle ratio, the cogging torque and the unbalanced electromagnetic force are minimized.

Therefore, it is possible to minimize the vibration and noise generated during rotation of the rotor 30. As a result, it is possible to improve the rotation performance of the motor.

Referring to FIGS. 4 and 9, the brush motor according to the present invention includes stators 20, each of which has a varying thickness t along the width direction W corresponding to the circumferential direction of the rotor 30.

Particularly, the thickness t1 of the middle portion among the width direction portions of each of the stators 20 is largest, and the thickness t2 becomes gradually smaller toward the both edge portions.

Preferably, the thickness ratio of the middle portion to both edge portions among the width direction portions of each of the stators 20 is 10:4.

The stators 20 of such a structure have a thickness which is largest in the middle portion and becomes smaller toward both edge portions. Therefore, the magnetic force increases in the middle portion, and the magnetic force decreases toward both edge portions.

In particular, the magnetic force in the middle portion of each of the stators 20 increases, and the magnetic force in the boundary portion between the stators 20 decreases.

Therefore, while not losing the rotation torque of the rotor 30 due to the attraction force and the repulsion force between the coils 36 of the rotor 30 and the stators 20 during the rotation of the rotor 30, it is possible to remarkably reduce the cogging torque generated due to a change in attraction force between the coils 36 of the rotor 30 and the boundary portion of the stators 20.

As a result, it is possible to remarkably reduce the vibration of the rotor 30 and the change in the rotation speed of the rotor 30 caused by the cogging torque, thereby improving the rotation performance of the motor.

Each of the stators 20 has a thickness gradually thinner from the middle portion to both edge portions and has a structure in which the magnetic force in the boundary portion between the stators 20 decreases. Accordingly, it is possible to reduce the ripple current generated due to the change in attraction force between the coils 36 and the boundary portion between the stators 20 and due to the resultant change in the magnetic field.

As a result, as shown in FIG. 5, it is possible to remarkably reduce the amplitude of the ripple current. This makes it possible to prevent generation of noise due to the ripple current and to prevent damage to a battery and various electric devices.

Referring again to FIG. 4, the brush motor of the present invention includes a pair of brushes 40 for supplying electric power to the respective commutators 34 of the rotor 30. The brushes 40 are fixedly installed on the inner circumferential surface of the motor housing 10.

Particularly, the brushes 40 are fixedly installed on the inner circumferential surface of the motor housing 10 corresponding to the commutators 34 at intervals of 90 degrees.

Each of the brushes 40 are configured to make frictional contact at least two commutators 34 at the same time. Each of the brushes 40 constructed as described above is used to apply electric power to at least two commutators 34.

According to the brush motor of the present invention having such a configuration, since the size of the coils 36 and the stator 20 of the rotor 30 is reduced, it is possible to have an output equivalent to that of a blower motor having the conventional 2-pole 12-slot 2-brush structure, thereby making it possible to reduce the size and weight of the motor.

As described above, the brush motor according to the present invention has a structure of 4 poles, 24 slots and 2 brushes. Thus, the present brush motor can have an output equivalent to that of a conventional brush motor of a 2-pole 12-slot 2-brush structure while reducing the size of the coils 36 of the rotor 30 and the stators 20. Thus makes it possible to reduce the size and weight of the brush motor.

Further, since the brush motor has a structure capable of reducing the size and weight thereof, it is possible to achieve the downsizing, slimming and weight-reducing of an air conditioner.

In addition, since the brush motor has a structure of 4 poles, 24 slots and 2 brushes, it is possible to reduce the size of the coils 36 of the rotor 30 and the stators 20 without loss of the rotation torque, consequently reducing the cogging torque generated between the coils 36 of the rotor 30 and the stators 20.

Since the cogging torque between the rotor 30 and the stators 20 can be reduced, it is possible to reduce the vibration of the rotor 30 and the fluctuation of a rotation speed of the rotor 30 caused by the cogging torque, consequently improving the rotation performance of the motor.

Furthermore, since the brush motor has a structure of 4 poles, 24 slots and 2 brushes, it is possible to reduce the size of the coils 36 of the rotor 30 and the stators 20 without loss of the rotation torque, eventually reducing the ripple current generated due to the change in magnetic field between the coils 36 and the stators 20.

Moreover, by reducing the ripple current generated due to the change in magnetic field between the coils 36 and the stators 20, it is possible to prevent generation of noise due to the ripple current and to prevent damage to a battery and various electric devices.

In addition, since the brush motor has a structure of 4 poles, 24 slots and 2 brushes so as to optimize the pole arc/angle ratio, which is a ratio of a magnet width to a pole gap, it is possible to reduce the size and weight of the brush motor and to minimize the generation of the cogging torque and the ripple current due to the change in magnetic field between the rotor 30 and the stators 20.

While a preferred embodiment of the present invention have been described above, the present invention is not limited to the above-described embodiment. Various modifications and changes may be made without departing from the scope and spirit of the present invention defined in the claims.

1. A brush motor having a 4-pole 24-slot 2-brush structure, comprising:
a motor housing;
a plurality of stators provided at intervals on an inner circumferential surface of the motor housing;
a rotor rotatably installed inside the stators;
a plurality of commutators installed on a rotation center shaft of the rotor; and
a plurality of brushes configured to supply electric power to the commutators, the rotor including a plurality of slots formed at intervals on an outer circumferential surface thereof and a plurality of coils wound in the slots, wherein the number of the stators provided at intervals on the inner circumferential surface of the motor housing is four, the number of the brushes configured to supply electric power to the commutators is two,
the number of the slots of the rotor for generating a rotation torque while exerting an attraction force and a repulsion force with respect to the four stators when energized or de-energized by the electric power is twenty four, and
the number of the coils wound in the slots is twenty four.

2. The brush motor of claim 1, wherein each of the stators has a varying thickness along a width direction corresponding to a circumferential direction of the rotor.

3. The brush motor of claim 2, wherein each of the stators has a largest thickness in a width direction middle portion and a gradually decreasing thickness in both edge portions.

4. The brush motor of claim 3, wherein a thickness ratio of the width direction middle portion to both edge portions is 10:4.

5. The brush motor of claim 1, wherein a pole arc/angle ratio in each of the stators falls within a range of 0.88 to 0.92.

6. The brush motor of claim 5, wherein the pole arc/angle ratio in each of the stators is set to satisfy the following equation (1):
0.88≤L1/R1≤0.92 (1)
where L1 denotes a length of one of permanent magnets provided in each of the stators, and R1 denotes a length obtained by dividing the circumferential length of a circle formed by a surface on which permanent magnets are located, by the number of permanent magnets.

7. The brush motor of claim 1, wherein the number of the commutators is set to twenty four so as to correspond to the number of the coils of the rotor.

8. The brush motor of claim 1, wherein the brushes are fixedly installed in the motor housing corresponding to the commutators so that the brushes can supply electric power to the commutators while making frictional contact with the commutators, and the brushes are installed at intervals of 90 degrees on an inner circumferential surface of the motor housing.

9. The brush motor of claim 8, wherein each of the brushes is configured to make frictional contact with at least two commutators at the same time and is configured to supply electric power to at least two commutators.

10. A blower for a vehicular air conditioner comprising the brush motor of claim 1.
